(19) United States
(12) Patent Application Publication
(10) Pub. No.: US 2025/0322820 A1
(43) Pub. Date: Oct. 16, 2025

(54) Text-To-Speech Progress-Aware Fulfillment and Response

(71) Applicant: Google LLC, Mountain View, CA (US)

(72) Inventors: Pu-sen Chao, Los Altos, CA (US); Alex Fandrianto, Los Gatos, CA (US); Arundhati Sharatchandra Bhat, San Carlos, CA (US)

(73) Assignee: Google LLC, Mountain View, CA (US)

(21) Appl. No.: 18/634,876

(22) Filed: Apr. 12, 2024

(51) Int. Cl. G10L 13/00; G10L 15/22

(52) U.S. Cl. CPC G10L 13/00; G10L 15/222; G10L 2015/228

(57) ABSTRACT

A method includes outputting, from an assistant-enabled device, a first text-to-speech (TTS) utterance generated from a first output transcription including a sequence of terms. While outputting the first TTS utterance from the assistant-enabled device, the method includes determining a corresponding playback status for each respective term of the sequence of terms, receiving a barge-in utterance spoken by a user, and identifying a subset of terms output from the assistant-enabled device before the user spoke the barge-in utterance based on the corresponding playback status of each respective term of the sequence of terms. The method also includes determining, based on the identified subset 10 of terms, a second output transcription responsive to the barge-in utterance spoken by the user. The method also includes outputting, from the assistant-enabled device, a second TTS utterance generated from the second output transcription.

### TECHNICAL FIELD

This disclosure relates to text-to-speech (TTS) progress-aware fulfillment and response.

### BACKGROUND

Digital assistants that execute on user devices have become increasingly popular in recent years. These digital assistants enable users to interact with the user devices in order to obtain information, access services, and/or perform various. To that end, the digital assistants may engage in a conversation with the users using speech recognition and natural language processing. For example, the user may direct a question towards the digital assistant whereby the digital assistant generates an answer to the question. Generally speaking, digital assistants are adept at holding conversations with users in a natural and intuitive manner. However, for some naturally occurring speech scenarios of a conversation, such as the user interrupting the digital assistant as the digital assistant is speaking, the digital assistant responds in an unnatural and uninformed manner.

### SUMMARY

One aspect of the disclosure provides a computer-implemented method that when executed on data processing hardware causes the data processing hardware to perform operations for generating text-to-speech (TTS) progress-aware responses. The operations include outputting, from an assistant-enabled device, a first TTS utterance generated from a first output transcription including a sequence of terms. While outputting the first TTS utterance from the assistant-enabled device, the operations include determining a corresponding playback status for each respective terms of the sequence of terms, receiving a barge-in utterance spoken by a user, and identifying a subset of terms output from the assistant-enabled device before the user spoke the barge-in utterance based on the corresponding playback status of each respective term of the sequence of terms. The operations also include determining a second output transcription responsive to the barge-in utterance spoken by the user based on the identified subset of terms. The operations also include outputting a second TTS utterance generated from the second output transcription from the assistant-enabled device.

Implementations of the disclosure may include one or more of the following optional features. In some implementations, the operations further include receiving an initial utterance spoken by the user and determining the first output transcription based on the initial utterance. The operations may further include determining the first output transcription without receiving an initial utterance spoken by the user. The corresponding playback status includes an output playback status or a not output playback status. In some examples, while outputting the first TTS utterance from the assistant-enabled device, the operations further include identifying a second subset of terms from the sequence of terms not output by the assistant-enabled device before the user spoke the barge-in utterance and terminating output of the second subset of terms.

In some implementations, receiving the barge-in utterance spoken by the user occurs after the assistant-enabled device begins outputting the first TTS utterance and before the assistant-enabled device finishes outputting the first TTS utterance. The operations may further include determining a context of the barge-in utterance based on the subset of terms. Here, determining the second output transcription is further based on the context.

In some examples, the operations further include assigning a playback timestamp to each respective term of the sequence of terms as the respective term is output from the assistant-enabled device and determining a barge-in timestamp of the barge-in utterance as the assistant-enabled device receives the barge-in utterance. In these examples, identifying the subset of terms is further based on the corresponding playback timestamp of each respective term of the sequence of terms and the barge-in timestamp. The barge-in utterance may include a hotword-free utterance.

Another aspect of the disclosure provides a system that includes data processing hardware and memory hardware storing instructions that when executed on the data processing hardware causes the data processing hardware to perform operations. The operations include outputting, from an assistant-enabled device, a first TTS utterance generated from a first output transcription including a sequence of terms. While outputting the first TTS utterance from the assistant-enabled device, the operations include determining a corresponding playback status for each respective terms of the sequence of terms, receiving a barge-in utterance spoken by a user, and identifying a subset of terms output from the assistant-enabled device before the user spoke the barge-in utterance based on the corresponding playback status of each respective term of the sequence of terms. The operations also include determining a second output transcription responsive to the barge-in utterance spoken by the user based on the identified subset of terms. The operations also include outputting a second TTS utterance generated from the second output transcription from the assistant-enabled device.

Implementations of the disclosure may include one or more of the following optional features. In some implementations, the operations further include receiving an initial utterance spoken by the user and determining the first output transcription based on the initial utterance. The operations may further include determining the first output transcription without receiving an initial utterance spoken by the user. The corresponding playback status includes an output playback status or a not output playback status. In some examples, while outputting the first TTS utterance from the assistant-enabled device, the operations further include identifying a second subset of terms from the sequence of terms not output by the assistant-enabled device before the user spoke the barge-in utterance and terminating output of the second subset of terms.

In some implementations, receiving the barge-in utterance spoken by the user occurs after the assistant-enabled device begins outputting the first TTS utterance and before the assistant-enabled device finishes outputting the first TTS utterance. The operations may further include determining a context of the barge-in utterance based on the subset of terms. Here, determining the second output transcription is further based on the context.

In some examples, the operations further include assigning a playback timestamp to each respective term of the sequence of terms as the respective term is output from the assistant-enabled device and determining a barge-in timestamp of the barge-in utterance as the assistant-enabled device receives the barge-in utterance. In these examples, identifying the subset of terms is further based on the corresponding playback timestamp of each respective term of the sequence of terms and the barge-in timestamp. The barge-in utterance may include a hotword-free utterance.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system executing a progress-aware digital assistant.

FIG. 2 is a schematic view of an example speech recognition model.

FIG. 3 is a schematic view of an example identification process.

FIG. 4 is a flowchart of an example arrangement of operations for a computer-implemented method of generating text-to-speech progress-aware responses.

FIG. 5 is a schematic view of an example computing device that may be used to implement the systems and methods described herein.

Like reference symbols in the various drawings indicate like elements.

### DETAILED DESCRIPTION

Digital assistants enable users to interact with user devices to obtain information, access services, and/or perform various tasks. For example, users may execute searches, get directions, and/or interact with third party computing services. Moreover, users may also be able to perform a variety of actions, such as ordering vehicles from ride-sharing applications, ordering goods or services (e.g., food delivery), controlling smart devices (e.g., light switches), and making reservations. Generally speaking, digital assistants are adept at holding conversation with users in a natural and intuitive manner. In some instances, digital assistants maintain prior inputs from the user to generate more informed responses. For example, the user might ask “where is the closest coffee shop?” to which the automated assistant might reply, “two blocks east.” Thereafter, the user might ask, “how late is it open?” By preserving at least some form of dialog context, the automated assistant is able to determine that the pronoun “it” refers to the “coffee shop.”

For some naturally occurring speech scenarios, however, the digital assistant is unable to generate natural and intuitive responses. In particular, the digital assistant may request a clarification from a user that interrupts the natural flow of the conversation. For example, in a food delivery application scenario, the digital assistant may output synthesized speech of “which one would you like to order? Apple, banana, orange, or watermelon” to which the user interrupts the digital assistant responding, “this one.” In this example, the user responds by speaking “this one” after the digital assistant has already started speaking, but before the digital assistant has stopped speaking. More specifically, the user response of “this one” refers to the orange option. Yet, not knowing what “this one” refers to, the digital assistant may be required to request a clarification from the user by asking “were you referring to apple, banana, orange, or watermelon?” This additional clarification required by the digital assistant interrupts the natural flow of conversation between the user and the digital assistant.

Accordingly, implementations herein are directed towards methods and systems of using a progress-aware digital assistant to generate text-to-speech (TTS) responses and fulfill actions characterized by the TTS responses. The progress-aware digital assistant may execute on an assistant-enabled device and/or a cloud computing environment. The progress-aware digital assistant outputs, from the assistant-enabled device, a first TTS utterance generated from a first output transcription that includes a sequence of terms. While outputting the first TTS utterance from the assistant-enabled device, the progress-aware digital assistant determines a corresponding playback status for each respective term of the sequence of terms, receives a barge-in utterance spoken by a user, and identifies a subset of terms output from the assistant-enabled device before the user spoke the barge-in utterance based on the corresponding playback status of each respective term of the sequence of terms. The progress-aware digital assistant also determines a second output transcription responsive to the barge-in utterance spoken by the user and based on the identified subset of terms, and subsequently outputs, from the assistant-enabled device, a second TTS utterance generated from the second output transcription.

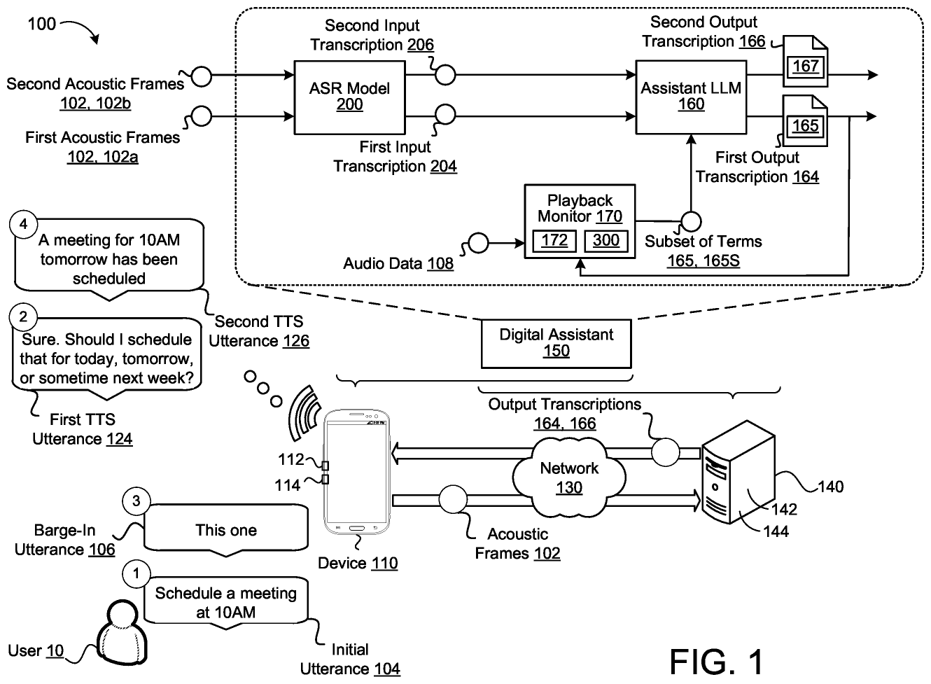

FIG. 1 illustrates an example system 100 for allowing a spoken conversation between a user 10 and a progress-aware digital assistant 150. The progress-aware digital assistant 150 (also referred to as simply “digital assistant 150”) may execute on a user device 110 associated with the user 10 to enable the user 10 and the digital assistant 150 to interact with one another through spoken conversation. The digital assistant 150 may access various components for facilitating the spoken conversation in a natural manner between the user 10 and the digital assistant 150. For instance, by using application programming interfaces (APIs) or other types of plug-ins, the digital assistant 120 may access an automated speech recognition (ASR) model 200, an assistant large language model (LLM) 160, and a playback monitor 170.

The system 100 includes an assistant-enabled device (AED) 110, a network 130, and a remote system 140. In some scenarios, the system 100 omits the network 130 and the remote system 140 such that all functionality of the digital assistant 150 (i.e., including the ASR model 200, the assistant LLM 160, and the playback monitor 170) executes on the AED 110. The AED 110 includes data processing hardware 112 and memory hardware 114. The AED 110 may include, or be in communication with, an audio capture device (e.g., an array of one or more microphones) for converting utterances 104, 106 spoken by the user 10 into a corresponding sequence of acoustic frames 102. In lieu of spoken input, the user 10 may input a textual representation via a user interface executing on the AED 110. In scenarios when the user 10 speaks an utterance 104, 106 captured by the audio capture device, the ASR model 200 executing on the AED 110 and/or the remote system 140 may process the corresponding audio data 102 to generate an input transcription 204, 206 of the utterance 104, 160. Here, the input transcription 204, 206 conveys a textual representation of the utterance 104, 106 spoken by the user 10 and is provided as input to the digital assistant 150.

The AED 110 may include any computing device capable of communicating with the remote system 140 via the network 130. The AED 110 includes, but is not limited to, desktop computing devices and mobile computing devices, such as laptops, tablets, smart phones, smart speakers/displays, digital assistant devices, smart appliances, internet-of-things (IoT) devices (e.g., headsets, smart glasses, and/or watches). The remote system 140 may be a distrusted system (e.g., a cloud computing environment) having scalable elastic resources. The resources include computing resources (e.g., data processing hardware) 142 and/or storage resources (e.g., memory hardware) 144. Additionally or alternatively, the remote system 140 may be a centralized system. The network 130 may be wired, wireless, or a combination thereof, and may include private networks and/or public networks, such as the Internet.

During a user turn (e.g., when the user 10 is speaking) of the spoken conversation between the user 10 and the progress-aware digital assistant 150, the AED 110 captures the sequence of acoustic frames 102 (e.g., characterizing an initial utterance 104 or a barge-in utterance 106 spoken by the user 10) directed towards the progress-aware digital assistant 150 to solicit a response from the assistant LLM 160. For example, the initial utterance 104 may specify a particular question that the user 10 would like the assistant LLM 160 to answer whereby the assistant LLM 160 generates a response that answers the question. The initial utterance 104 may similarly correspond to a request for information and the assistant LLM 160 may generate a response conveying the requested information. In yet another example, the initial utterance 104 may request the assistance digital assistant 150 to perform an action whereby the digital assistant 150 performs the action and generates a response confirming the action. For instance, the initial utterance 104 may correspond to “call mom” whereby the digital assistant 150 initiates a phone application to initiate a call with a contact labeled ‘mom’ and outputs a response of “calling mom.”

The user 10 may speak the initial utterance 104 in a natural language whereby the ASR model 200 performs speech recognition on a first sequence of acoustic frames 102, 102a characterizing the initial utterance 104 to generate a first input transcription 204. Similarly, as described in greater detail below, the user 10 may speak a barge-in utterance 106 in a natural language whereby the ASR model 200 performs speech recognition on a second sequence of acoustic frames 102, 102b characterizing the barge-in utterance 106 to generate a second input transcription 206.

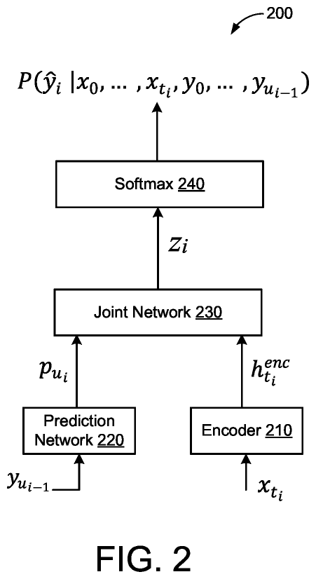

Referring to FIG. 2, an example ASR model 200 may include a Recurrent Neural Network-Transducer (RNN-T) model architecture which adheres to latency constraints associated with interactive applications. The use of the RNN-T model architecture is exemplary, and the frame alignment-based transducer model 200 may include other architectures such as listen attend spell (LAS), transformer-transducer, and conformer-transducer model architectures among others. Other ASR models 200 may include encoder-decoder architectures where the encoder includes a stack of multi-head attention layers/blocks for encoding audio frames and the decoder includes a stack of multi-head attention layers/blocks for decoding the encoded audio frames into a corresponding transcription. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder reads a sequence of d-dimensional feature vectors (e.g., acoustic frames 102 (FIG. 1)) x=(x₁, x₂, . . . , x_{T}), where xₜ∈ [symbol] _{d}, and produces at each output step a higher-order feature representation. This higher-order feature representation is denoted as

$${h}_{1}^{e n c} , … , {h}_{T}^{e n c} .$$

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{_{i−1}}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the input transcription 204, 206 (FIG. 1).

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 102, which allows the RNN-T model to be employed in a streaming fashion, the non-streaming fashion, or some combination thereof.

In some examples, the encoder network (i.e., audio encoder) 210 of the RNN-T model 200 includes a stack of self-attention layers/blocks, such as conformer blocks. Here, each conformer block includes a series of multi-headed self attention, depth wise convolution and feed-forward layers. The prediction network 220 may have two 2,048-dimensional LSTM layers, each of which is also followed by a 640-dimensional projection layer. Alternatively, the prediction network 220 may include a stack of transformer or conformer blocks, or an embedding look-up table in lieu of LSTM layers. Finally, the joint network 230 may also have 640 hidden units.

Referring back to FIG. 1, the assistant LLM 160 is configured to receive, as input, the input transcriptions 204, 206 generated by the ASR model 200 and generate, as output, corresponding output transcriptions 164, 166. The assistant LLM 160 may include a trained LLM trained on a corpus of conversational training data. Thus, the assistant LLM 160 is trained to receive textual inputs and generate textual outputs. More specifically, the assistant LLM 160 generates a first output transcription 164 based on the first input transcription 204 and generates a second output transcription 166 based on the second input transcription 206. That is, when the first input transcription 204 corresponds to a question asked by the user 10, the assistant LLM 160 generates the first output transcription 164 including a sequence of terms 165 that answers the question. Each term 165 of the sequence of terms 165 may correspond to grapheme, character, number, wordpiece, and/or word. For example, the ASR model 200 may generate the first input transcription 204 of “what year did World War I start?” based on the initial utterance 104 spoken by the user 10 and the assistant LLM 160 generates a corresponding first output transcription 164 of “July 1914” that answers the initial utterance 104.

FIG. 1 shows the assistant LLM 160 generating the first output transcription 164 based on the first input transcription 204 corresponding to the initial utterance 104 spoken by the user 10. However, in some examples, the user 10 does not speak any initial utterance 104 and the assistant LLM 160 generates the first output transcription 164 without receiving any first input transcription 204 corresponding to the initial utterance 104 spoken by the user 10. In these examples, the assistant LLM 160 may receive a notification and generate the first output transcription 164 based on the notification. For instance, the user 10 may set a recurring daily reminder for the digital assistant 150 to remind the user 10 to take medication at 10 AM. Thus, at 10 AM the digital assistant 150 may receive the notification to remind the user 10 and generate the first output transcription 164 of “reminder to take your medication” based on the notification. Notably, in this scenario, the digital assistant 150 generated the first output transcription 164 responsive to the notification rather than based on an utterance spoken by the user 10.

The digital assistant 150 transmits the first output transcription 164 including the sequence of terms 165 to the AED 110 causing the AED 110 to generate a first TTS utterance 124. Here, a TTS system may execute on the AED 110. Optionally, a TTS system executing on the remote system 140 may generate the first TTS utterance 124 and transmit an audio file containing the first TTS utterance 124 to the AED 110 for audible output therefrom. The first TTS utterance 124 may include synthetic speech that is audibly output from one or more speakers of the AED 110. In some scenarios, the user 10 speaks the barge-in utterance 106 while the AED 110 is audibly outputting the synthesized speech of the first TTS utterance 124. As used herein, the barge-in utterance 106 refers to any speech spoken by the user 10 that interrupts the synthesized speech being output from the AED 110. That is, the AED 110 may receive the barge-in utterance 106 spoken by the user 10 after the AED 110 begins outputting the first TTS utterance 124 and before the AED 110 finishes outputting the first TTS utterance 124. The barge-in utterance 106 may include a hotword-free utterance. Hotwords are predetermined phrases configured to invoke speech recognition on digital assistants, such as “hey computer.” Thus, the hotword-free utterance does not include such predetermined phrase and simply includes an utterance directed towards the digital assistant 150.

In the example shown, at a time 1, the user 10 speaks the initial utterance 104 of “schedule a meeting at 10 AM” for which the digital assistant 150 generates the first output transcription 164 of “Sure. Should I schedule that for today, tomorrow, or sometime next week?” which the AED 110 outputs as the first TTS utterance 124 at time 2. Time 1 refers to a point in time that occurs before time 2. In this example, at time 3, the user 10 speaks the barge-in utterance 106 of “this one” as the AED 110 is outputting the first TTS utterance 124. More specifically, the user 10 speaks “this one” right after the AED 110 outputs synthetic speech corresponding to “tomorrow” and before the AED outputs synthetic speech corresponding to “or sometime next week?” Thus, time 3 refers to a point in time that at least partially overlaps time 2. To be clear, the barge-in utterance 106 refers to, without explicitly identifying, one of multiple possible options conveyed in the first TTS utterance 124. Notably, a naive digital assistant may be able to determine that “this one” refers to one of today, tomorrow, or sometime next week, but may be unable to disambiguate which particular one of these options “this one” refers to. Thus, the naive digital assistant may be required to obtain a clarification from the user 10 regarding which particular option “this one” refers to such that the user 10 would be required to speak an additional refinement utterance of “tomorrow”.

Accordingly, to disambiguate which option “this one” refers to and without requiring the user to provide a refinement utterance or otherwise provide any additional input, the playback monitor 170 of the digital assistant 120 receives the first output transcription 164 including the sequence of terms 165 and audio data 108 characterizing the barge-in utterance 106 spoken by the user 10 and the synthesized speech of the first TTS utterance 124 output by the AED 110. The playback monitor 170 is configured to perform an identification process 300 to identify a subset of terms 165, 165S from the sequence of terms 165 of the first output transcription 165. The subset of terms 165S represent terms audibly output by the AED 110 before the barge-in utterance 106 was spoken by the user 10. To that end, for each respective term 165 of the sequence of terms 165, the playback monitor 170 determines a corresponding playback status 172 of the respective term 165 based on the audio data 108. Thereafter, based on the corresponding playback status 172 of each respective term 165, the playback monitor 170 identifies the subset of terms 165S from the sequence of terms 164. The playback monitor 170 outputs the identified subset of terms 165S to the assistant LLM 160.

In some examples, the playback monitor 170 assigns a corresponding playback timestamp to each respective term 165 of the sequence of terms 165 as the respective term 165 is output from the AED 110. Moreover, the playback monitor 170 determines a barge-in timestamp of the barge-in utterance as the AED receives the barge-in utterance 106. As such, the playback monitor 170 may further identify the subset of terms 165S based on the corresponding playback timestamp of each respective term 165 of the sequence of terms 165 and the barge-in timestamp. That is, terms 165 having a playback timestamp that occurs before the barge-in timestamp are added to the subset of terms 165S.

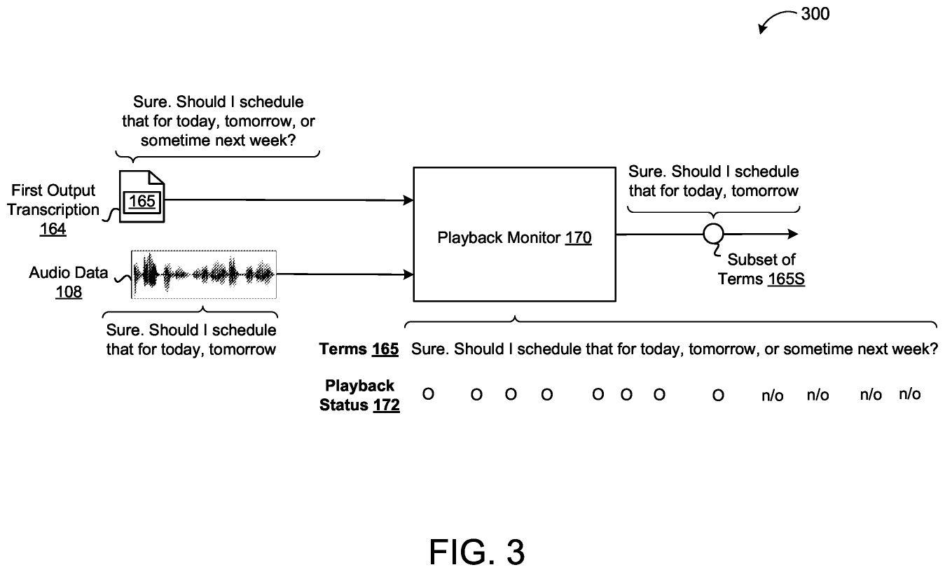

FIG. 3 shows an example identification process 300 performed by the playback monitor 170. In the example shown, the playback monitor 170 receives the first output transcription 164 including the sequence of terms 165 corresponding to “Sure. Should I schedule that for today, tomorrow, or sometime next week?” which corresponds to the response to the initial utterance 104 spoken by the user 10 (FIG. 1). Continuing with the example, the playback monitor 170 receives the audio data 108 characterizing the synthesized speech of the first TTS utterance 124 output by the AED 110 before the user 10 spoke the barge-in utterance 106. Notably, the audio data 108 does not characterize synthesized speech of “or sometime next week?” because the AED 110 did not output this synthesized speech before the user 10 spoke the barge-in utterance 106. Accordingly, based on the first output transcription 164 and the audio data 108, the playback monitor 170 determines a corresponding playback status 172 for each respective term 165 of the sequence of terms 165. Here, the playback status 172 includes an output playback status denoted by “o” or a not output playback status denoted by “n/o.” The output playback status indicates that the AED 110 has already output the respective term 165 before the user 10 spoke the barge-in utterance 106. On the other hand, the not output playback status indicates that the AED has not yet output the respective term before the user 10 spoke the barge-in utterance 106.

In the example shown, the playback monitor 170 determines an output playback status for each of the terms 165 “Sure. Should I schedule that for today, tomorrow” and determines a not output playback status for each of the terms 165 “or sometime next week?” As such, the identification process 300 identifies the subset of terms 165S from the sequence of terms 165 based on the corresponding playback status 172 of each term 165. That is, the identification process 300 adds terms 165 having the output playback status to the subset of terms 165S and discards terms having the not output playback status. In the example shown, the playback monitor 170 identifies the subset of terms 165S of “Sure. Should I schedule that for today, tomorrow” representing the terms 165 output from the AED 110 before the user 10 spoke the barge-in utterance 106.

Referring again to FIG. 1, the subset of terms 165S represent which terms have been output by the AED 110 before the user 10 spoke the barge-in utterance 106. Advantageously, the subset of terms 165S may provide contextual information as to what the barge-in utterance 106 spoken by the user 10 may be referring to. That is, continuing with the above example, since the AED 110 has only output the terms “Sure. Should I schedule that for today, tomorrow” and the second input transcription 204 corresponds to “this one” the digital assistant 120 may determine that “this one” does not refer to “sometime next week” since those terms 165 have not yet been output by the AED 110. Moreover, since “this one” was spoken right after the AED 110 output the term 165 of “tomorrow” the digital assistant 120 may determine that “this one” most likely refers to “tomorrow”. For instance, the ASR model 200 may timestamp the second input transcription 206 for the barge-in utterance 106 and the playback monitor 170 may determine that the timestamp for the second input transcription is closer to the corresponding time

Accordingly, based on the second input transcription 206 corresponding to the barge-in utterance 106 spoken by the user 10 and the subset of terms 165S, the assistant LLM 160 determines a second output transcription 166 including a second sequence of terms 167 that is responsive to the second input transcription 206. Here, the assistant LLM 160 may determine a context 162 of the second input transcription 206 based on the subset of terms 165S. The context 162 may include a temporal context representing a relationship between when the barge-in utterance 106 was spoken in relation to each term 165 from the subset of terms 165S. Thus, the assistant LLM 160 may determine the second output transcription 166 based on the context 162. Advantageously, based on the context 162 and the subset of terms 165S, the assistant LLM 160 determines the contextually relevant second output transcriptions 166. Namely, in the example shown, the assistant LLM 160 generates the second output transcription 166 of “A meeting for 10 AM tomorrow has been scheduled” without soliciting any further clarification from the user 10 regarding what “this one” refers to.

Thereafter, at time 4, the digital assistant 150 transmits the second output transcription 166 including the sequence of terms 167 to the AED 110 causing the AED 110 to generate the second TTS utterance 126. Optionally, the remote system 140 may generate the second TTS utterance 126 from the second output transcription 166 and transmit an audio file containing the second TTS utterance 126 to the user device 110 for audible output therefrom. The AED 110 audibly outputs synthesized speech representing the second TTS utterance 126 based on the second output transcription 166. In some examples, the playback monitor 170 identifies a second subset of terms from the sequence of terms 165 not output by the AED 110 before the user 10 spoke the barge-in utterance 106. In these examples, the digital assistant 120 may terminate the audible output of the second subset of terms in response to receiving the barge-in utterance 106.

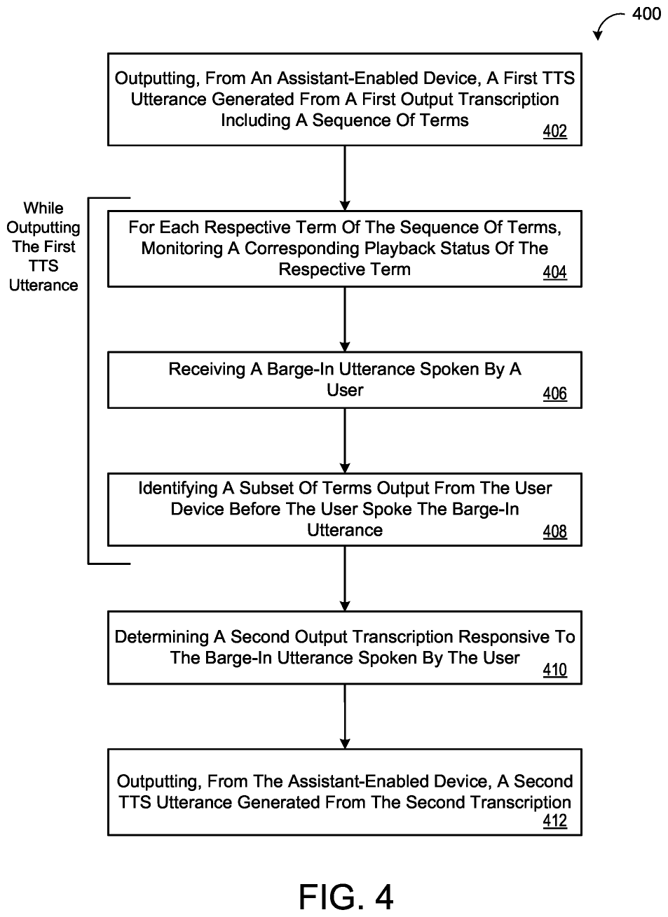

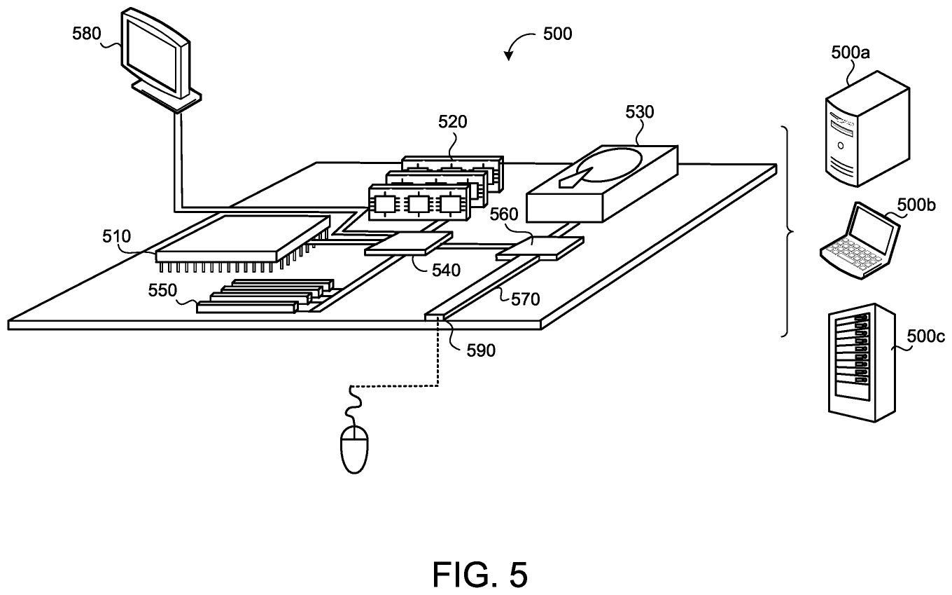

FIG. 4 is a flowchart of an exemplary arrangement of operations for a computer-implemented method 400 of generating TTS progress-aware responses. The method 400 may execute on data processing hardware 510 (FIG. 5) using instructions stored on memory hardware 520 (FIG. 5). The data processing hardware 510 and the memory hardware 520 may reside on the user device 110 and/or the cloud computing environment 140 of FIG. 1 each corresponding to a computing device 500 (FIG. 5).

At operation 402, the method 400 includes outputting, from an assistant-enabled device (AED) 110, a first text-to-speech (TTS) utterance 124 generated from a first output transcription 164 that includes a sequence of terms 165. While outputting the first TTS utterance 124 from the AED 110, the method 400 performs operations 404-408. At operation 404, the method 400 includes, for each respective term 165 of the sequence of terms 1655, determining a corresponding playback status 172 of the respective term 165. At operation 406, the method 400 includes receiving a barge-in utterance 106 spoken by a user 10. At operation 408, the method 400 includes identifying a subset of terms 165, 165S output from the AED 110 before the user 10 spoke the barge-in utterance 106. At operation 410, the method 400 includes determining, based on the identified subset of terms 165S, a second output transcription 166 responsive to the barge-in utterance 106 spoken by the user 10. At operation 412, the method 400 includes outputting, from the AED 110, a second TTS utterance 126 generated from the second output transcription 166.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
outputting, from an assistant-enabled device, a first text-to-speech (TTS) utterance generated from a first output transcription comprising a sequence of terms;
while outputting the first TTS utterance from the assistant-enabled device:
for each respective term of the sequence of terms, determining a corresponding playback status of the respective term;
receiving a barge-in utterance spoken by a user; and
identifying, based on the corresponding playback status of each respective term of the sequence of terms, a subset of terms output from the assistant-enabled device before the user spoke the barge-in utterance;
determining, based on the identified subset of terms, a second output transcription responsive to the barge-in utterance spoken by the user; and
outputting, from the assistant-enabled device, a second TTS utterance generated from the second output transcription.

2. The computer-implemented method of claim 1, wherein the operations further comprise:
receiving an initial utterance spoken by the user; and
determining the first output transcription based on the initial utterance.

3. The computer-implemented method of claim 1, wherein the operations further comprising determining the first output transcription without receiving an initial utterance spoken by the user.

4. The computer-implemented method of claim 1, wherein the corresponding playback status comprises an output playback status or a not output playback status.

5. The computer-implemented method of claim 1, wherein, while outputting the first TTS utterance from the assistant-enabled device, the operations further comprise:
identifying, based on the corresponding playback status of each respective term of the of the sequence of terms, a second subset terms from the sequence of terms not output by the assistant-enabled device before the user spoke the barge-in utterance; and
in response to receiving the barge-in utterance, terminating output of the second subset of terms.

6. The computer-implemented method of claim 1, wherein receiving the barge-in utterance spoken by the user occurs:
after the assistant-enabled device begins outputting the first TTS utterance; and
before the assistant-enabled device finishes outputting the first TTS utterance.

7. The computer-implemented method of claim 1, wherein the operations further comprise:
determining, based on the subset of terms, a context of the barge-in utterance,
wherein determining the second output transcription is further based on the context of the barge-in utterance.

8. The computer-implemented method of claim 1, wherein the operations further comprise:
assigning a corresponding playback timestamp to each respective term of the sequence of terms as the respective term is output from the assistant-enabled device; and
determining a barge-in timestamp of the barge-in utterance as the assistant-enabled device receives the barge-in utterance.

9. The computer-implemented method of claim 8, wherein identifying the subset of terms is further based on the corresponding playback timestamp of each respective term of the sequence of terms and the barge-in timestamp.

10. The computer-implemented method of claim 1, wherein the barge-in utterance comprises a hotword-free utterance.

11. A system comprising:
data processing hardware; and
memory hardware in communication with the data processing hardware, the memory hardware storing instructions that when executed on the data processing hardware cause the data processing hardware to perform operations comprising:
outputting, from an assistant-enabled device, a first text-to-speech (TTS) utterance generated from a first output transcription comprising a sequence of terms;
while outputting the first TTS utterance from the assistant-enabled device:
for each respective term of the sequence of terms, determining a corresponding playback status of the respective term;
receiving a barge-in utterance spoken by a user; and
identifying, based on the corresponding playback status of each respective term of the sequence of terms, a subset of terms output from the assistant-enabled device before the user spoke the barge-in utterance;
determining, based on the identified subset of terms, a second output transcription responsive to the barge-in utterance spoken by the user; and
outputting, from the assistant-enabled device, a second TTS utterance generated from the second output transcription.

12. The system of claim 11, wherein the operations further comprise:
receiving an initial utterance spoken by the user; and
determining the first output transcription based on the initial utterance.

13. The system of claim 11, wherein the operations further comprising determining the first output transcription without receiving an initial utterance spoken by the user.

14. The system of claim 11, wherein the corresponding playback status comprises an output playback status or a not output playback status.

15. The system of claim 11, wherein, while outputting the first TTS utterance from the assistant-enabled device, the operations further comprise:
identifying, based on the corresponding playback status of each respective term of the of the sequence of terms, a second subset terms from the sequence of terms not output by the assistant-enabled device before the user spoke the barge-in utterance; and
in response to receiving the barge-in utterance, terminating output of the second subset of terms.

16. The system of claim 11, wherein receiving the barge-in utterance spoken by the user occurs:
after the assistant-enabled device begins outputting the first TTS utterance; and
before the assistant-enabled device finishes outputting the first TTS utterance.

17. The system of claim 11, wherein the operations further comprise:
determining, based on the subset of terms, a context of the barge-in utterance,
wherein determining the second output transcription is further based on the context of the barge-in utterance.

18. The system of claim 11, wherein the operations further comprise:
assigning a corresponding playback timestamp to each respective term of the sequence of terms as the respective term is output from the assistant-enabled device; and
determining a barge-in timestamp of the barge-in utterance as the assistant-enabled device receives the barge-in utterance.

19. The system of claim 18, wherein identifying the subset of terms is further based on the corresponding playback timestamp of each respective term of the sequence of terms and the barge-in timestamp.

20. The system of claim 11, wherein the barge-in utterance comprises a hotword-free utterance.
